(19) United States
(12) Patent Application Publication
(10) Pub. No.: US 2014/0372155 A1
(43) Pub. Date: Dec. 18, 2014

(54) SYSTEM AND METHOD FOR PARKING RESERVATION AND FINDING PARKING SPACE SUITABLE FOR USER'S VEHICLE SIZE

(71) Applicant: XEROX CORPORATION, Norwalk, CT (US)

(72) Inventors: Yao Rong Wang, Webster, NY (US); Panya Chanawangsa, Williamsville, NY (US); Orhan Bulan, Rochester, NY (US); David Cummins, Washington, DC (US); Matthew Darst, Chicago, IL (US)

(21) Appl. No.: 13/918,364

(22) Filed: Jun. 14, 2013

(51) Int. Cl. G06Q 10/02; G06Q 50/30

(52) U.S. Cl. CPC G06Q 10/02; G06Q 50/30
USPC 705/5

(57) ABSTRACT

In implementation, a computer-implemented method, a system, and a non-transitory computer readable medium for managing parking space availability in a parking zone is disclosed. The computer-implemented method includes obtaining a request for a parking reservation for a parking space in a parking zone for a vehicle from a client device, wherein the client device is associated with a user, a vehicle, or both the user and the vehicle; determining that a parking space is available in the parking zone for the vehicle; and providing the parking reservation to the client device.

### BACKGROUND

Embodiments are generally related to parking reservation systems. Embodiments also relate to video-based parking occupancy detection technology.

The management of an entity's available parking is a challenge to those tasked with administration of that entity. Parking is a resource that has both a diverse user group and a high level of economic and environmental impact. The available supply of parking is often much smaller than the demand for it, but is also continually changing. This results in shortages that need to be fairly distributed. Price fluctuations to meet changes in demand are also impossible to institute because of lack of timely knowledge as to the changes.

Price is not the only means by which people have tried to manage parking. They have also sought to ration parking through the use of time limits for use of the parking spaces. However, the dispersed nature of parking spaces makes monitoring of the spaces by traditional methods ineffective.

Tools exist currently to aide in the management of parking resources. The deployment of parking meters greatly enhances the ability to collect monies and monitor the use of parking spaces. However, these meters also create further management issues, as these pieces of equipment require regular preventative maintenance as well as occasional repair. Skilled personnel must perform such actions. This places an additional burden on the administrative body to monitor not only the spaces, but also the dispersed equipment, parts, and personnel, and to determine when a particular meter is out of order.

All of this monitoring and management is the challenge of parking administrators. It generally requires all or almost all of the manager's time simply to keep the operation running leaving little time to devote to actual balancing of use and availability of parking spaces to the general public. In this regard, the current approaches to parking management fail to perform the function they were designed to achieve.

Real-time parking occupancy detection systems are an emerging technology in parking management One system for parking occupancy detection involves the use of puck-style/ultrasonic sensors that output a binary signal when detecting a vehicle in a parking stall. FIG. 1 illustrates such a sensor for parking occupancy detection in on-street parking and parking lot situations, respectively. In FIG. 1, “puck-style” sensors 15, 17, 19 and 3, 5, 7 are shown with respect to a vehicle 21 parked in a parking lot or parking zone.

“Puck-style” in-ground sensors have been implemented in several cities providing real-time data for drivers reporting street occupancy in a city. As an alternative to sensor based solutions, video-based solutions have also been recently proposed to determine parking occupancy. In these systems, video cameras are deployed on-site to monitor parking spots and the captured video is processed real-time to report available parking space to drivers.

Besides parking occupancy detection systems, another emerging technology in parking management is parking payment using a mobile phone. In one prior art implementation of this system, a zone number is assigned to each block that is indicated by signs in the parking block. A driver can make the parking payment at the time of parking using the mobile phone application by entering information including credit card number, parking zone number, license plate number, and duration of parking. In another embodiment, driver enters the departure time at the time of leaving and hence the vehicle is charged according to the time it stays in the parking area. In any case, the vehicle information is sent to a central processor to which enforcement officers have access to in order to identify vehicles that are allowed to park in a parking zone for a specific time of the day. FIG. 2 illustrates a pictorial view 34 of a sign 37 indicating the zone number for a particular block in an area for mobile phone parking payment in Washington, D.C. Such systems have already started to take place of traditional coin based parking meters and are likely to be deployed in large-scale implementations in many other cities in the future.

The present disclosure relates to a video-based method and system for efficient vehicle detection/localization in still images obtained from a fixed video camera. The disclosed method and system are applicable to parking space management. However, it is to be appreciated that the present exemplary embodiments are also applicable to other like applications.

One challenge that parking management companies face while managing on-street parking is an accurate detection of available spaces. Conventional methods for detecting vehicle occupancy in parking spaces include non-video based sensing solutions. For example, “puck-style” sensors, shown in FIG. 1, typically use magnetometer readings to sense when a vehicle is detected in a parking space. The detected information is wirelessly communicated to interested parties. One disadvantage associated with these sensor-based methods is a high cost for installation and maintenance of the sensors. In addition, the maintenance or replacement of a sensor may reduce parking efficiency if a parking space is made unavailable for the service work.

Another method being explored is a video-based solution. This method is shown in FIG. 3 and includes monitoring on-street parking spaces using non-stereoscopic video cameras. The cameras output a binary signal to a processor, which uses the data for determining occupancies of the parking spaces. As shown in FIG. 3, a parking occupancy detection system 10 is based on the use of video cameras such as, for example, video camera 28. The video camera 28 in the configuration shown in FIG. 3 can monitor vehicles 32, 34, 36 within an FOV (Field of View) 16 of the video camera 28. The video camera 28 is configured to monitor the length 12 of a parking zone or parking lot and vehicles situated/parked with in various parking slots 18, 20, 22, 24, 26. The video camera 28 can communicate with, for example, an antenna 30 and supported by a platform 32.

One shortcoming of both technologies is that they are designed for, and limited to, single-space parking configurations. On-street parking can be provided in two different configurations. A first configuration is single-space parking, also known as stall-based parking, in which each parking space is defined in a parking area by clear boundaries. The parking spaces are typically marked by lines that are painted on the road surface to designate one parking space per vehicle. A second configuration is multi-space or free-flow parking where there are no defined boundaries between parking spaces. At present, many departments of transportation are transitioning from single-space parking configurations to the multi-space parking configurations. Cities are eliminating parking meters and single-space parking configurations to reduce maintenance and other costs. The sensor-based methods are best suited for parking areas where painted lines typically demark a defined parking space for a single vehicle. However, an incorporation of the sensor-based methods for use in multi-space parking configurations is conceptually difficult and expensive to continue. Accordingly, this transition reduces a need for inground and other sensor-based methods.

Given the comparatively lower cost of a video surveillance camera, a video-based solution offers a better value if it is incorporated into a management scheme for monitoring multi-space parking configurations, as well as some applications of single-space street parking. Another advantage of a video-based solution is that one video camera can typically monitor and track several parking spots, whereas multiple sensors may be needed to reliably monitor one parking space in the single-space parking configuration. Additionally, maintenance of the video cameras is likely to be less disruptive than maintenance of in-ground sensors.

Meeting the parking needs of motorists requires more than simply finding a balance between supply and demand, yet the capability to efficiently allocate and manage on-street parking remains elusive, even when parking needs are significant, recurring, and known ahead of time. For instance, urban parking spaces characteristically undergo periods of widely skewed demand and utilization, with low demand and light use in some periods, often during the night, and heavy demand and use at other times. As well, merely finding available parking is only the start, as subsequent occupancy of a parking space must also be permissible under applicable rules. There are many parking spot finding applications (parkers) available in the market already, and ways for reserving on-street or curbside parking space have been proposed and patents and patent applications are filed. However, these parkers and parking space reservation systems are all based on ground sensor input data for parking spot availability. As such, these systems can only give a binary output for each parking spot with a default parking size. In many applications, what a user needs to know (reserve) is the availability of a parking spot suitable for his/her vehicle size. This is particularly true for business applications such as parking at commercial loading zone.

### SUMMARY

In implementations, a computer-implemented method for managing parking space availability in a parking zone is disclosed. The computer-implemented method can include obtaining a request for a parking reservation for a parking space in a parking zone for a vehicle from a client device, wherein the client device is associated with a user, a vehicle, or both the user and the vehicle; determining that the client device is registered with a parking management database; determining that a parking space is available in the parking zone for the vehicle based on information stored in the parking management database; and providing the parking reservation to the client device.

In implementations, the method can further include obtaining real-time data on the parking zone from video-based occupancy detection system; and determining a number of vehicles parked in the parking zone from the real-time data.

In implementations, the determining that the parking space is available can further include obtaining a record from the parking management database for the client device, wherein the record comprising information based on characteristics of the vehicle; and comparing the characteristics of the vehicle with a list of available parking spaces; determining which of the available parking spaces are suitable for the vehicle based on the characteristics of the vehicle.

In implementations, the parking reservation can include a confirmation number.

In implementations, the method can further include providing instructions to a parking meter associated with the parking space that is available to the vehicle to indicate that the parking space has been reserved.

In implementations, the method can further include receiving a request from a client device to register with the parking management database, wherein the request comprising any, or combinations of, information related to user, a client device, and a vehicle.

In implementations, the method can further include determining a time duration for which the vehicle is parked; and calculating a parking fee based on the time duration that is determined.

In implementations, the method can further include generating a bill according to registration data associated with the vehicle.

In implementations, a system for managing parking space availability in a parking zone is disclosed. The system can include one or more processors; and a computer readable medium comprising instructions that cause the one or more processors to perform a method comprising: obtaining a request for a parking reservation for a parking space in a parking zone for a vehicle from a client device, wherein the client device is associated with a user, a vehicle, or both the user and the vehicle; determining that the client device is registered with a parking management database; determining that a parking space is available in the parking zone for the vehicle based on information stored in the parking management database; and providing the parking reservation to the client device.

In implementations, a non-transitory computer readable storage medium is disclosed that comprising instructions that cause one or more processors to perform a method for managing parking space availability in a parking zone, the method comprising: obtaining a request for a parking reservation for a parking space in a parking zone for a vehicle from a client device, wherein the client device is associated with a user, a vehicle, or both the user and the vehicle; determining that the client device is registered with a parking management database; determining that a parking space is available in the parking zone for the vehicle based on information stored in the parking management database; and providing the parking reservation to the client device.

### BRIEF DESCRIPTION OF THE DRAWINGS

FIG. 1 shows a “puck-style” sensor-based method for detecting parking space occupancy according to the PRIOR ART.

FIG. 2 shows an example sign indicating parking zone number for mobile phone parking payment in Washington, D.C.

FIG. 3 shows an example a video-based method for detecting parking space occupancy.

FIGS. 4A-4C shows example views of a mobile phone application, which can be implemented in accordance with one of more aspects of the disclosed embodiments.

FIGS. 5A-5C shows additional example view of the mobile phone application.

FIG. 6 shows an example portion of a web-based system that takes occupancy data from a video detection platform and then compares it with the registration/login data, accordance with one or more aspects of the disclosed embodiments,

FIG. 7 shows an example method of the parking reservation platform in accordance with one or more aspects of the disclosed embodiments.

FIG. 8 is an example block diagram of a processing system that can be adapted for use in accordance with one or more embodiments.

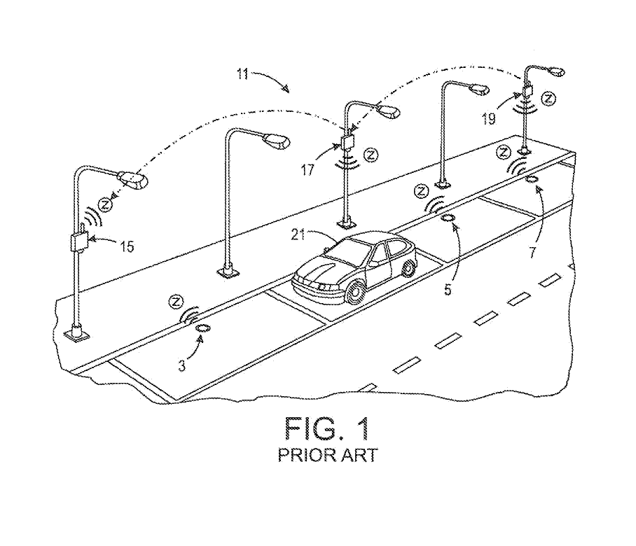

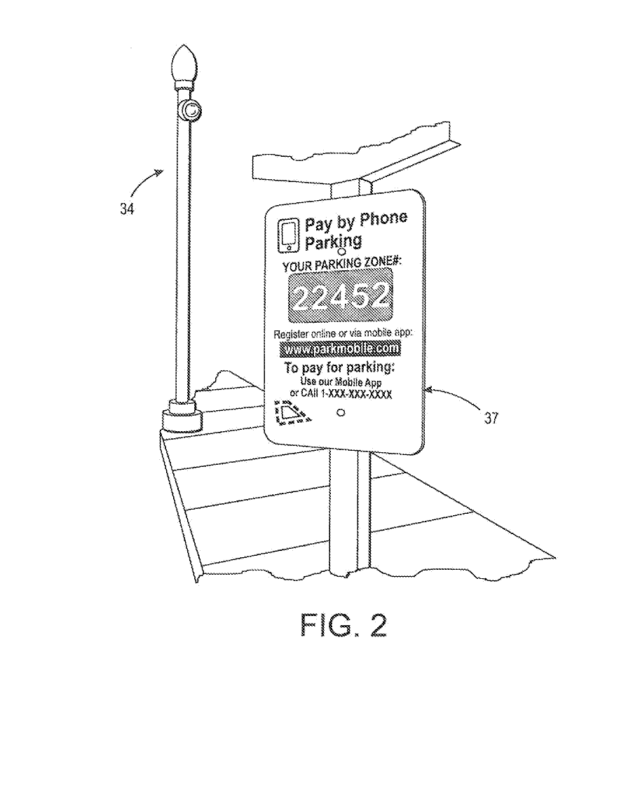

### DETAILED DESCRIPTION

This disclosure provides a computationally efficient vision-based vehicle detection method and system from images acquired with fixed cameras operatively associated with a parking reservation management system.

The disclosed embodiments describe an automatic and exact parking bill payment method and system that a driver can access. Such a parking reservation management system not only detects parking occupancy, but also monitors the duration of parking. An example for such a parking reservation management system includes a video-based parking management system.

As indicated earlier, parking occupancy detection systems provide real-time data about the occupancy of streets in a city and already been implemented in several cities. Similarly, mobile phone or web-based parking payment systems can provide an easy and convenient way for the driver to transmit a vehicle's identity (e.g., license plate number) to a central server as well as to make parking payment for parked vehicle.

Prior approaches require the knowledge of the parking vehicle's payment amount, thereby requiring the driver to pre-pay for parking time. Pre-paying for parking time may not be convenient to drivers, as parking time may not be accurately estimated in advance. The disclosed embodiments do not require pre-paying for parking time. The disclosed method/system fuses street occupancy data with parking payment/registration/login information derived from parking meters or the driver's smartphone application when parking his/her vehicle and registered/logged in.

In implementations, a computer-implemented method, a system, and a computer-readable medium are disclosed for locating and/or reserving a parking space that would be suitable for the user's vehicle size. The parking reservation platform can be implemented as an application operating on a computing device, such as a mobile computing device like a smartphone. The computing device can include a device integrated with or otherwise associated with a vehicle of the user or the user themselves. For example, the parking location and/or reservation system can be incorporated into an application and/or service of an infotainment (information and entertainment) platform and/or GPS platform of a vehicle. The user can register with the parking reservation platform using a registration service associated with the parking reservation platform. The user can by supply user and vehicle information to the service. For example, the user can supply information regarding contact information of the user(s) to associate with the account, billing account information (e.g., credit card information), and one or more vehicle-type information (e.g., make and model).

Once registered, the user can log into the account, for example, by using a username and password that the user established at registration. The user can then enter location information into the parking reservation platform, via a user-interface, that the user desires to park the vehicle. Alternatively and/or additionally, location information can be acquired from a GPS system or other location acquiring methods (e.g., triangulation) and provided to the parking reservation platform. For example, the location information can include a street address, a street block destination, or cross-street location. Based on the location information entered or acquired by the parking reservation platform, the parking reservation platform can provide information related to the parking availability of the location. For example, the parking reservation platform can provide to the computing device and which can be displayed by the application, a number of parking space available to accommodate the vehicle at or near the location that the user requested. The user can then request details related to the parking spaces that are available. For example, the details can include the size (length) for each parking space located. In the instance of single space parking, this size can be a default number, which is typically 20 ft. In the instances of multiple space parking, the size can be determined from a video analytics of parking space images acquired by a video camera system.

Once the user has chosen an appropriate parking location from the options provided by the parking reservation platform, the user can reserve the chosen parking space. For example, the user can select the parking space from the application and the selection can be provided to the parking reservation platform. A ticket (e.g., electronic ticket) with a confirmation number can be provided to the computing device from the parking reservation platform. The parking reservation platform can also record the time at which the parking space was requested and/or when the ticket was issued. The confirmation number associated with the ticket can be used to show that parking permission was been granted. Alternatively and/or additionally, the confirmation number can be entered into a parking meter associated with the reserved parking space to begin a billing cycle for the user.

Upon receiving the reservation request from the user, the parking reservation platform can compare the vehicle type (i.e., size) with the available parking size for each parking space. For example, the service can use the vehicle type (i.e., size) on record (e.g., provided during or subsequent to the registration) or the reservation request can include the vehicle type (i.e., size). The service can provide to the user all available parking spaces available to the user or can provide a subset of those parking spaces meeting the vehicle type restriction. In the case of single space parking, if the requested vehicle size from the reservation request is larger than the size of one space, then two adjoining parking spaces can be used as a signal vehicle parking space.

Upon accepting the reservation, the server will send a confirmation number to the user. Upon accepting the reservation, the server will send a notice to the parking meter to lock the reserved space. If a random driver tries to park into the reserved space, or his/her vehicle is partially into the reserved space, without given the confirmation number, the video camera will observe this vehicle, and the parking meter will print a notice at the time the driver buys the parking ticket stating that your parking space or part of your parking space is already reserved by somebody else. If the random diver is registered his/her vehicle, a message can also be sent to his/her smartphone telling him/her that this parking space is already reserved. If the driver keeps parking there, it will be treated as a violation. So this space can only be parked by the reserver with a confirmation number.

Once the user is finished with the parking space, the user can send a request, via the application, to the parking reservation platform. The time at which the request to exit the parking space can be recorded and used to calculate a parking duration for which the user can be billed. Alternatively and/or additionally, the parking reservation platform can send a command to the parking meter to that the pervious confirmation number is no longer valid.

After the parking space has been reserved or after the vehicle has been parked in the reserved parking space, the parking reservation platform can update the number of vehicles parked and/or the number of available parking spaces using updated data from a video analytics system associated with the parking area.

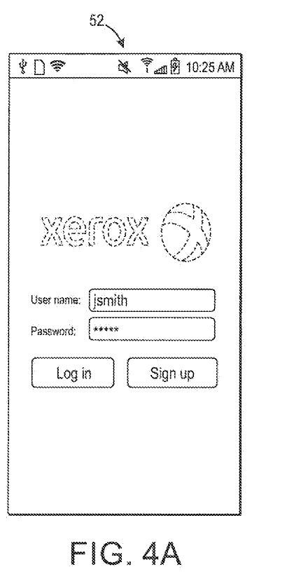

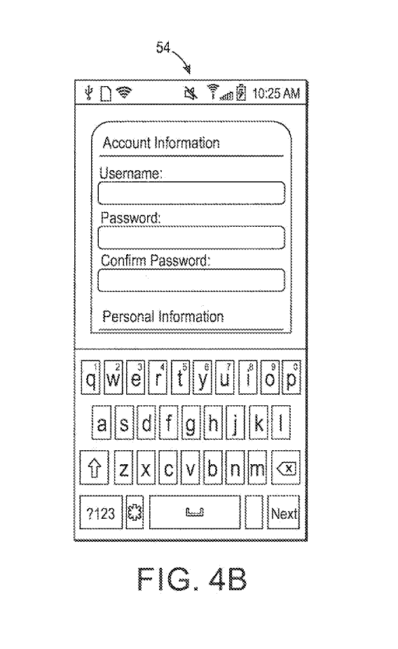

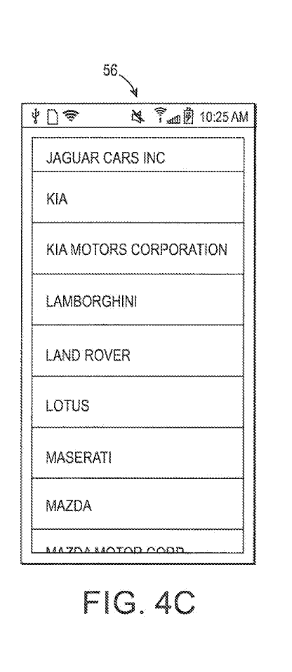

A mobile phone parking register/payment application can be implemented in the context of, for example, an Android/iPhone platform to enable users to register and enter parking information. FIGS. 4A-4C illustrate example pictorial views of an example of such a mobile phone application, in accordance with one or more aspects of the disclosed embodiments. Examples of such an application can include screen 52 that allow the user to log into or sign up for an account. Screen 54 allows the user to establish an account by providing a username and password. Screen 56 allows the user to select one or more vehicles to link with the account. The vehicle list can include characteristics of the vehicles (e.g., size of the vehicle) that can be used with the parking reservation platform to locate suitable parking spaces for the size of the vehicle.

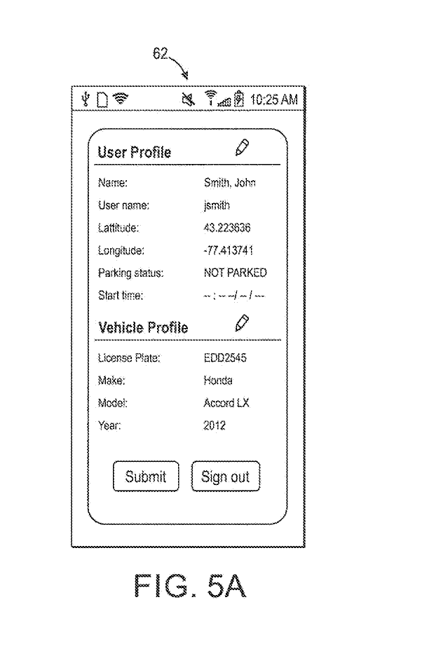

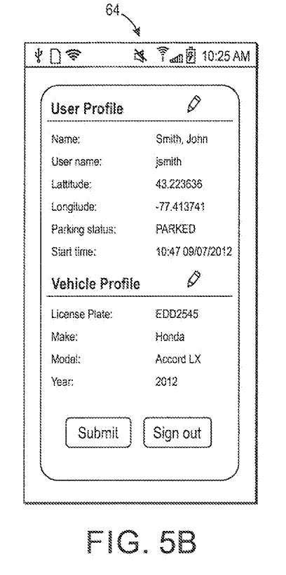

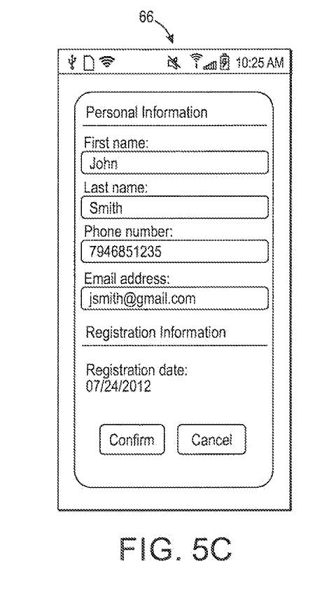

FIGS. 5A-5C shows examples of such the application after registration including screens 62 and 64 that show a user profile (name, username, location (latitude and longitude), parking status, start time, etc.) and vehicle profile (license plate, make, model, year) and a screen 66 that show personal information (first name, last name, phone number, email address, etc.) for the user.

This application allows the user to register his/her vehicle for the first time with the vehicle information, which contains the vehicle's identification such as the license plate number, information on how to bill the user for parking fee, and other additional information. When the user parks his/her car, he/she is required to initiate a parking session by logging in to the application and pressing the submit button. In doing so, his/her account information as well as the GPS coordinates are transmitted to the central server. Otherwise, the video occupancy detection system can treat the vehicle as a violation unless the user has pre-paid at the parking meter. The video occupancy detection platform of the disclosed embodiments will monitor the vehicle as well as the duration of parking.

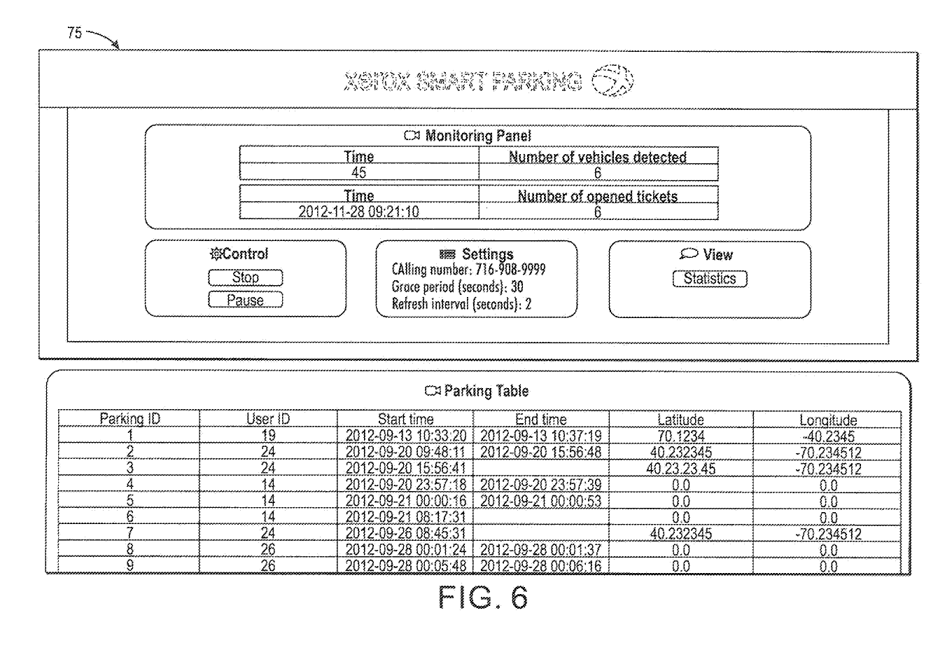

FIG. 6 illustrates a portion of a web-based system 75 that takes the occupancy data from the disclosed video detection method/system and then compares it with the registration/login data, accordance with one or more aspects of the disclosed embodiments. The web-based system 75 can include a monitoring panel that shows information including the total of vehicles detected by the video occupancy detection platform, current time, number of reservation tickets open (available). The web-based system 75 can also include a parking table that shows individualized information for each vehicle parked.

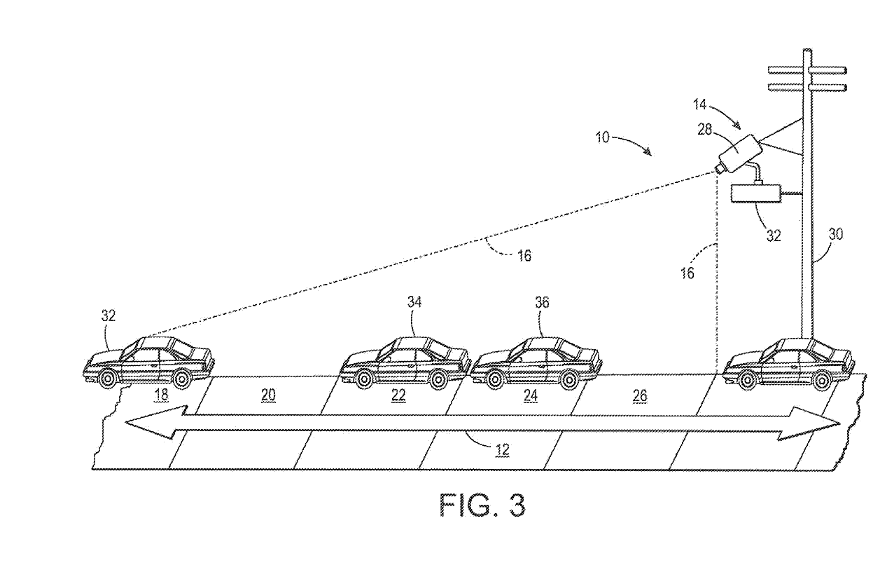

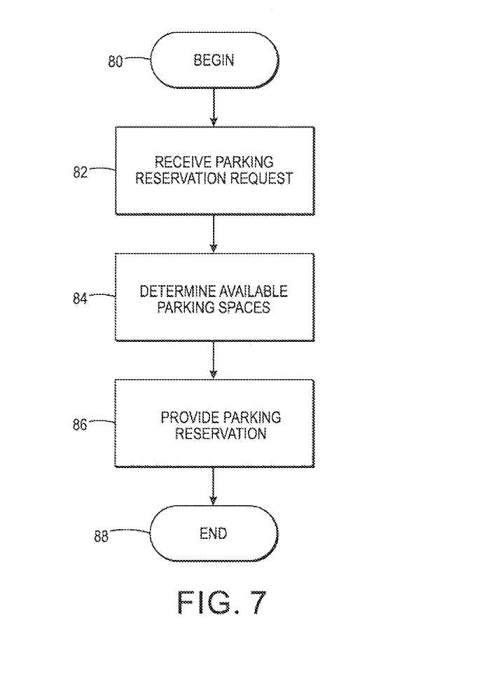

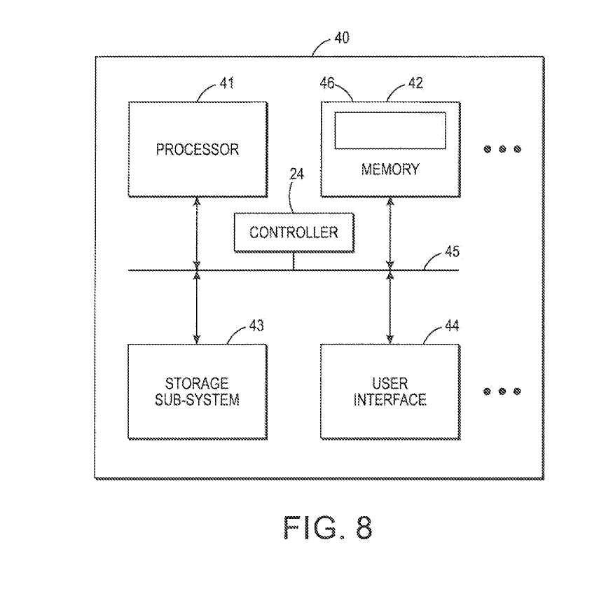

FIG. 7 illustrates a high-level flow chart depicting logical operational steps of a method for wireless parking registration and payment, in accordance with an embodiment. As indicated at 80, the process can begin. Real-time data from a parking occupancy detection system (e.g., from a video-based occupancy detection system 10 shown in FIG. 3) can be continually acquired, including the parking duration for each parked vehicle. Based on the data from the occupancy detection system, the number of vehicles in the parking zone can be determined.

At 82, a parking reservation request can be received by the user. For example, when a user approaches an area for which parking is desired, the user can request a parking reservation using the mobile phone application. The mobile phone application can acquire location information for a UPS module associated with the mobile phone or the vehicle and provide the location information with the parking reservation request to the parking reservation platform.

At 84, the parking reservation platform can receive the parking reservation request and determine whether a parking space is available to be reserved. The parking reservation platform can receive updated occupancy data from the video occupancy detection system and compare any available parking space in a desired parking area with the vehicle characteristic information (e.g., size of the vehicle, make and model), which can be provided at time of registration or anytime subsequent to registration.

If the parking reservation platform identifies one or more available parking spaces suitable for the vehicle, the parking reservation platform can provide the options to the mobile phone application. The parking options provided can include details of the location and/or size of the available parking spaces. The user can then send the desired parking selection to the parking reservation platform for reservation. If the parking reservation platform cannot identify any suitable parking spaces based on the vehicle size, the parking reservation platform can determine is any two or more suitable adjacent parking spaces can be combined to provide a single parking space and then provide that option to the user. If no suitable parking spaces are available, the parking reservation platform can inform the user and provide options for searching other parking areas for available parking.

At 86, the parking reservation platform can provide the mobile phone application a parking reservation based on the parking choose selected by the user. The parking reservation can include a confirmation number, which can be used to verify that the parking space has been reserved and can be used to unlock an associated parking meter with the parking space.

At 88, the process can end.

The disclosed methods/systems can be implemented in the context of hardware circuits, and/or some parts can be implemented in software in any computer language, run by conventional processing hardware such as a general-purpose microprocessor, or application specific integrated circuits for example.

For example, such methods and/or systems may be implemented as a controller and can be implemented as hardware, computer software, or combinations of both. Such a controller may include a general purpose processor, an embedded processor, an application specific integrated circuit (ASIC), a field programmable gate array (FPGA) or other programmable logic device, discrete gate or transistor logic, discrete hardware components, or any combination designed to perform the functions described herein. A processor may also be implemented as a combination of computing devices, e.g., a combination of an FPGA and a microprocessor, a plurality of microprocessors, one or more microprocessors in conjunction with an FPGA, or any other such configuration.

Embodiments can also be realized via a processor system. Such a processing system may include a computing device or processing engine, e.g., a microprocessor, a server, etc. Any of the methods described above according to embodiments of the present disclosure or claimed may be implemented in, for example, a processing system 40.

The server can be configured to receive another message from the mobile or onboard device of the parking vehicle to end the parking session, in which case the parking duration of the vehicle is calculated from the time of the beginning parking message to the time of the ending parking message. The server can also be configured to receive no message from the mobile or the on-board device of the parking vehicle for ending the parking session, in which case the parking duration for the vehicle is calculated from the time of the beginning parking message to the time of detecting the parking vehicle moving out of the parking space. In one example, the detection of the vehicle moving out of the parking space can be enabled by video analytics of a camera.

Note that some parking occupancy detection systems are based on the use of inground sensors output the number of parking stalls occupied in a block, which is typically same as the number of parked vehicles. This is because street parking in some cites is still based on the situation where a parking stall has clear boundaries (e.g., typically marked by lines painted on the road surface) specified for the parking space for each vehicle. In this case, the result of the operation depicted at block 56 will be exactly the output of the occupancy detection system. Some cities, however, are eliminating single-space parking and moving into multi-space parking for maintenance cost and other reasons. Other cities will likely follow suit.

FIG. 9 illustrates one possible configuration of processing system 40 that can include, for example, at least one customizable or programmable processor 41 coupled to a memory subsystem 42 that includes at least one form of memory, e.g., RAM, ROM, and so forth. It is to be noted that the processor 41 or processors may be a general purpose, or a special purpose processor, and may be for inclusion in a device, e.g., a chip that has other components that perform other functions.

Thus, one or more aspects of the method according to embodiments of the present disclosure can be implemented in digital electronic circuitry, or in computer hardware, firmware, software, or in combinations of them. The processing system may include a storage subsystem 43 that has at least one disk drive and/or CD-ROM drive and/or DVD drive. In some cases, storage subsystem 43 may include, for example, a USB drive or a port for access a USB storage drive or Flash drive. In some implementations, a display system, a keyboard, and a pointing device may be included as part of a user interface 44 to provide for a user to manually input information such as parameter values. An example of such a user interface is a GUI (Graphical User Interface). Ports for inputting and outputting data may be included.

More elements such as network connections, interfaces to various devices, and so forth, may be included, but are not illustrated in FIG. 7. The various elements of the processing system 40 may be coupled in various ways, including via a bus subsystem 45 shown in FIG. 3 for simplicity as a single bus, but which will be understood to those in the art to include a system of at least one bus. The memory of the memory subsystem 42 may at some time hold part or all of a set of instructions that when executed on the processing system 40 implements the steps of the method embodiments described herein. A module 46 (e.g., a software module) stored within memory 42 may contain such instructions. For example, module 46 may contain instructions for carrying out the various steps or logical operations shown in the various blocks of FIG. 6.

Embodiments can also include a computer program product, which provides the functionality of any of the methods according to the present disclosure when executed on a computing device such as a processing engine. Software according to the present disclosure, when executed on a processing engine, can contain code segments that provide, for example, software and instructions thereof for carrying out the steps or logical operations shown in FIG. 6 and operations with respect to the various components shown in other figures herein.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or determining or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CO-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A computer-implemented method for managing parking space availability in a parking zone, the computer-implemented method comprising:
obtaining a request for a parking reservation for a parking space in a parking zone for a vehicle from a client device, wherein the client device is associated with a user, a vehicle, or both the user and the vehicle;
determining that a parking space is available in the parking zone for the vehicle; and
providing the parking reservation to the client device.

2. The computer-implemented method of claim 1, wherein the determining that the parking space is available in the parking zone for the vehicle is based on vehicle information stored in a parking management database.

3. The computer-implemented method of claim 2, further comprising determining that the client device is registered with the parking management database;

4. The computer-implemented method of claim 1, further comprising:
obtaining real-time data on the parking zone from a video-based occupancy detection system; and
determining a number of vehicles parked in the parking zone from the real-time data.

5. The computer-implemented method of claim 2, wherein the determining that the parking space is available further comprising:
obtaining a record from the parking management database for the client device, wherein the record comprising information based on characteristics of the vehicle; and
comparing the characteristics of the vehicle with a list of available parking spaces;
determining which of the available parking spaces are suitable for the vehicle based on the characteristics of the vehicle.

6. The computer-implemented method of claim 1, wherein the parking reservation comprises a confirmation number.

7. The computer-implemented method of claim 1, farther comprising providing instructions to a parking meter associated with the parking space that is available to the vehicle to indicate that the parking space has been reserved.

8. The computer-implemented method of claim 2, further comprising receiving a request from the client device to register with the parking management database, wherein the request comprising any, or combinations of, information related to user, a client device, and a vehicle.

9. The computer-implemented method of claim 1, further comprising:
determining a time duration for which the vehicle is parked; and
calculating a parking fee based on the time duration that is determined.

10. The computer-implemented method of claim 7, further comprising generating a bill according to registration data associated with the vehicle.

11. A system for managing parking space availability in a parking zone, the system comprising:
one or more processors; and
a computer readable medium comprising instructions that cause the one or in processors to perform a method comprising:
obtaining a request for a parking reservation for a parking space in a parking zone for a vehicle from a client device, wherein the client device is associated with a user, a vehicle, or both the user and the vehicle;
determining that a parking space is available in the parking zone for the vehicle; and
providing the parking reservation to the client device.

12. The system of claim 11, wherein the determining that the parking space is available in the parking zone for the vehicle is based on vehicle information stored in a parking management database.

13. The system of claim 11, wherein the one or more processors are further operable to execute the computer-executable components stored within the memory to perform:
obtaining real-time data on the parking zone from a video-based occupancy detection system; and
determining a number of vehicles parked in the parking zone from the real-time data.

14. The system of claim 12, wherein the determining that the parking space is available further comprising:
obtaining a record from the parking management database for the client device, wherein the record comprising information based on characteristics of the vehicle; and
comparing the characteristics of the vehicle with a list of available parking spaces;
determining which of the available parking spaces are suitable for the vehicle based on the characteristics of the vehicle.

15. The system of claim 11, wherein the parking reservation comprises a confirmation number.

16. The system of claim 11, wherein the one or more processors are further operable to execute the computer-executable components stored within the memory to perform providing instructions to a parking meter associated with the parking space that is available to the vehicle to indicate that the parking space has been reserved.

17. The system of claim 11, wherein the one or more processors are further operable to execute the computer-executable components stored within the memory to perform receiving a request from the client device to register with a parking management database, wherein the request comprising any, or combinations of, information related to user, a client device, and a vehicle.

18. The system of claim 11, wherein the one or more processors are further operable to execute the computer-executable components stored within the memory to perform:
determining a time duration for which the vehicle is parked; and
calculating a parking fee based on the time duration that is determined.

19. The system of claim 18, wherein the one or more processors are further operable to execute the computer-executable components stored within the memory to perform generating a bill according to registration data associated with the vehicle.

20. A non-transitory computer readable storage medium comprising instructions that cause one or more processors to perform a method for managing parking space availability in a parking zone, the method comprising:
obtaining a request for a parking reservation for a parking space in a parking zone for a vehicle from a client device, wherein the client device is associated with a user, a vehicle, or both the user and the vehicle;
determining that a parking space is available in the parking zone for the vehicle; and
providing the parking reservation to the client device.

21. The non-transitory computer readable storage medium of claim 20, wherein the determining that the parking space is available in the parking zone for the vehicle is based on vehicle information stored in a parking management database.

22. The non-transitory computer readable storage medium of claim 20, further comprising:
obtaining real-time data on the parking zone from video-based occupancy detection system; and
determining a number of vehicles parked in the parking zone from the real-time data.

23. The non-transitory computer readable storage medium of claim 20, further comprising:
obtaining a record from a parking management database for the client device, wherein the record comprising information based on characteristics of the vehicle; and
comparing the characteristics of the vehicle with a list of available parking spaces;
determining which of the available parking spaces are suitable for the vehicle based on the characteristics of the vehicle.

24. The non-transitory computer readable storage medium of claim 20, wherein the parking reservation comprises a confirmation number.
